(19) United States
(12) Patent Application Publication
(10) Pub. No.: US 2019/0284477 A1
(43) Pub. Date: Sep. 19, 2019

(54) PROCESSING WASTE INTO CARBON CHAR

(71) Applicant: Wilson Bio-Chemical Limited, York (GB)

(72) Inventor: Thomas Steven WILSON, Sheffield (GB)

(21) Appl. No.: 16/356,132

(22) Filed: Mar. 18, 2019

(30) Foreign Application Priority Data
Mar. 16, 2018 (GB) 1804205.1

(51) Int. Cl. C10B 49/02; C10B 53/02; C10B 23/00; C10B 57/14; B09B 3/00; C10J 3/82

(52) U.S. Cl. CPC C10B 49/02; C10B 53/02; C10B 23/00; C10J 2300/0946; B09B 3/0091; C10J 3/82; C10B 57/14

(57) ABSTRACT

Apparatus for processing waste-derived cellulose fibre into carbon char comprises an autoclave for treating waste with steam to produce processed material. The processed material includes cellulose fibre and plastics. The apparatus also includes a drying system for drying the cellulose fibre, and a torrefying unit for torrefying the dried cellulose fibre to produce carbon char. Thermal conversion means for thermally converting either said plastics or said VOCs provides heat for at least one of the autoclave, the drying system and the torrefying unit.

### CROSS REFERENCE TO RELATED APPLICATIONS

This application claims priority from United Kingdom Patent Application No. 18 04 205.1, filed 16 Mar. 2018, the whole contents of which is incorporated herein by reference in its entirety.

### BACKGROUND OF THE INVENTION

The present invention relates to apparatus and a method for processing waste into carbon char.

It is known to process waste using an autoclave to produce clean cellulose fibre. However, the uses for this fibre are limited because it is still considered by most authorities to be waste, even though it has been sterilised.

The procedures available for disposing of waste are largely limited to burying it or burning it. There is a movement towards reducing landfill, and incineration is widely seen as producing too many greenhouse gases.

### BRIEF SUMMARY OF THE INVENTION

According to an aspect of the present invention, there is provided apparatus for processing waste-derived cellulose fibre into carbon char, comprising an autoclave for treating waste with steam to produce processed material, said processed material including cellulose fibre and plastics, a drying system for drying said cellulose fibre, and a torrefying unit for torrefying said dried cellulose fibre to produce carbon char and VOCs, and thermal conversion means for thermally converting either said plastics or said VOCs, in order to provide heat for at least one of said autoclave, said drying system or said torrefying unit.

According to a second aspect of the invention, there is provided a method of producing carbon char from waste, comprising the step of processing waste by treating said waste with high pressure steam to produce processed material that includes cellulose fibre and plastics, and torrefying said cellulose fibre to produce carbon char and VOCs; wherein heat used during said step of processing waste is produced by thermally converting at least one of said plastics and said VOCs.

### BRIEF DESCRIPTION OF THE SEVERAL VIEWS OF THE DRAWINGS

FIG. 1 shows an apparatus embodying the invention;

FIG. 2 shows a recycling unit shown in FIG. 1;

FIG. 3 shows an energy generation unit shown in FIG. 1;

FIG. 4 shows a steam treatment unit shown in FIG. 2;

FIG. 5 shows a fibre processing unit shown in FIG. 1;

FIG. 6 shows a torrefying unit shown in FIG. 5;

FIG. 7 shows a drying unit shown in FIG. 6; and

FIG. 8 details steps taken to carry out a method embodying the invention.

### DETAILED DESCRIPTION OF EMBODIMENTS OF THE INVENTION

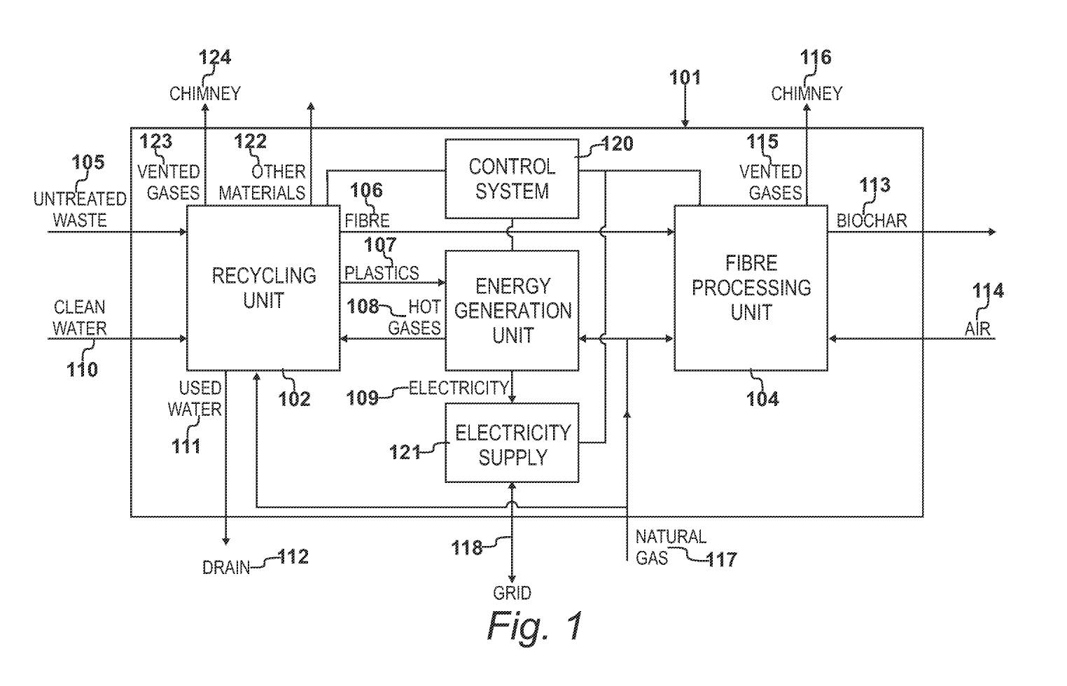

### FIG. 1

FIG. 1 shows apparatus 101, which is an embodiment of the invention. It includes a recycling unit 102, an energy generation unit 103, a fibre processing unit 104, a control system 120, and an electricity supply 121.

Untreated waste 105 enters recycling unit 102 where it is processed and sorted into cellulose fibre 106, plastics 107, and other materials 122, which includes non-organic materials such as metals and bricks. The recycling unit needs a supply of clean water 110, and used water 111 is routed to drain 112. Cooled and cleaned gases 123 are vented to atmosphere via a chimney 124.

Plastics 107 are passed to energy generation unit 103, where they are used to generate heat for the recycling unit in the form of hot gases 108, and electricity 109. Electricity is routed to electricity supply 121, which supplies electricity to all the units and systems in apparatus 101 (the details of this are not shown). In the case that the electricity generated by energy generation unit 103 is insufficient, for example in the case of the breakdown of energy generation unit 103, power may be drawn from the grid 118. However, in normal use there will be no requirement for this. Electricity may also be supplied to the grid in the case of over-production.

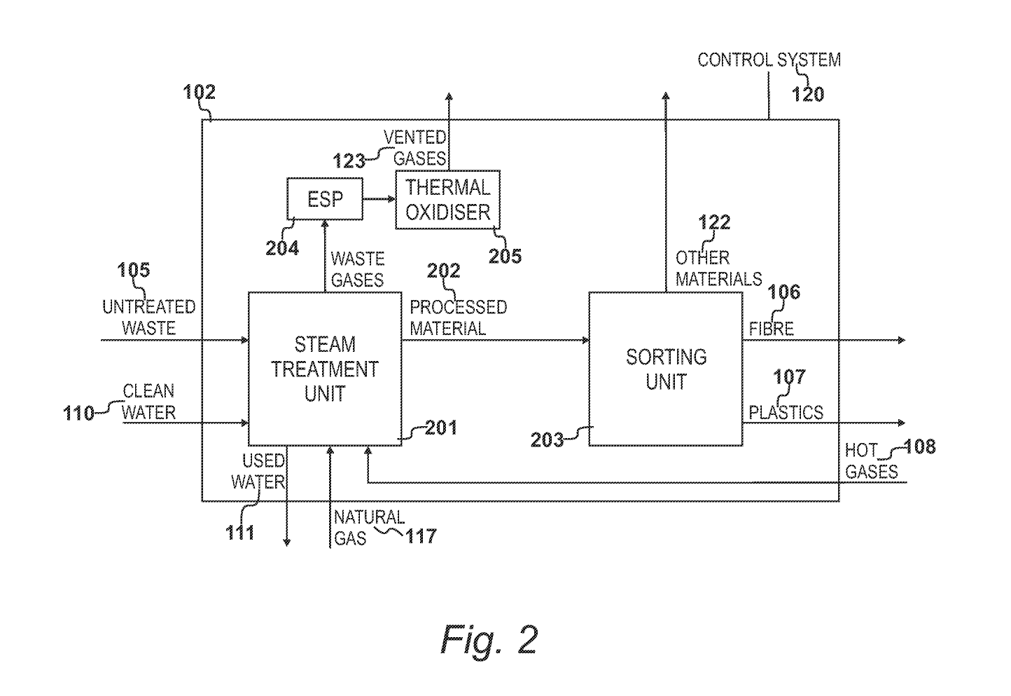

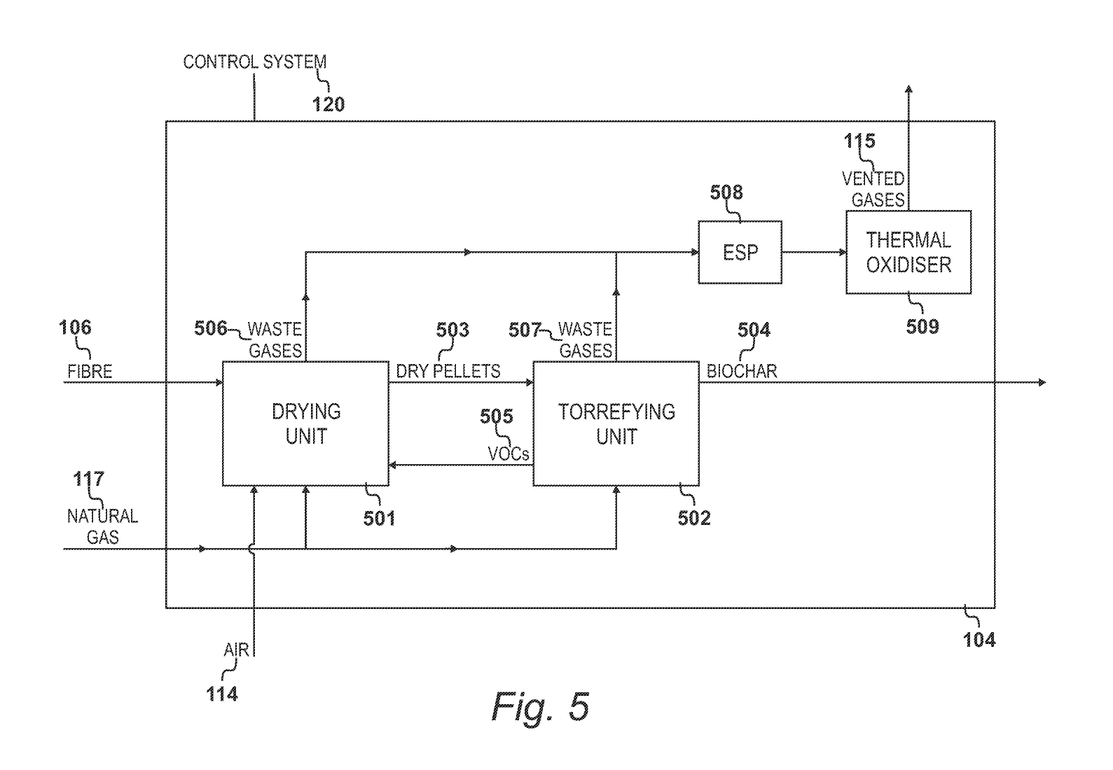

Fibre 106 is passed from recycling unit 102 to fibre processing unit 104 which processes it into carbon char, or biochar, 113. The fibre processing unit requires a supply of air 114, and cooled and cleaned gases 115, including the air, are vented to atmosphere via a chimney 116. In other embodiments, a single chimney may be used. This is dependent mainly upon the distance between the units and the capacity of the cooling equipment (which will be described further with reference to FIGS. 2 and 5).

Control system is connected to all units within apparatus 101. It controls the entire process and provides feedback to operators on process, performance, and environmental systems, including valves, Temperatures, flow meters, burner status, and so on. Any suitable computer system and display may be used, and any appropriate methods of connecting it to the various control elements and sensors are envisaged.

Under normal operating conditions, apparatus 101 is self-sufficient, running entirely on fuel and electricity produced from waste 105. However, in the case that the fuel needs supplementing, for example in the case of a breakdown of a part, natural gas 117 may be provided to recycling unit 102, energy generation unit 103, or fibre processing unit 104, in order that the apparatus need not be shut down. Apparatus 101 is designed to operate continuously, in order to both maximise the amount of waste processed and avoid the inefficiencies associated with cooldowns and restarts.

Apparatus 101 takes untreated waste 105, which is generally considered to be difficult to dispose of, and turns it into carbon char, which has many uses. The applicant has obtained end of waste certification for carbon char produced from waste using the apparatus described herein, meaning that it can be used for the same purposes as carbon char produced from any other biomass. However from an environmental perspective it is preferable, as it is not produced using a virgin product such as wood.

Carbon char has a higher calorific value than the cellulose fibre that is torrefied, and is also more dense. It is no sulphur content and less nitrogen than coal, and can therefore be classified as clean coal, and can be burnt in power stations with lower emissions than coal. It can also be used as a soil sequestrant, and with fertilisers added it can be sold as a conditioner and fertiliser for the agricultural and horticultural markets.

The conversion of waste into carbon char is therefore preferable to sending the waste to landfill. It is also preferable to incinerating the waste, as the apparatus described herein uses each element of the waste—organic matter, plastics, and other waste—in a different way, thus greatly increasing the efficiency of the system over simple incineration, which cannot combust everything completely due to it all being burnt together at the same temperature.

### FIG. 2

FIG. 2 shows recycling unit 102, which comprises steam treatment unit 201, sorting unit 203, electrostatic precipitator 204, and thermal oxidiser 205. Control system 120 provides monitoring and control of recycling unit 102 (the details of this are not shown).

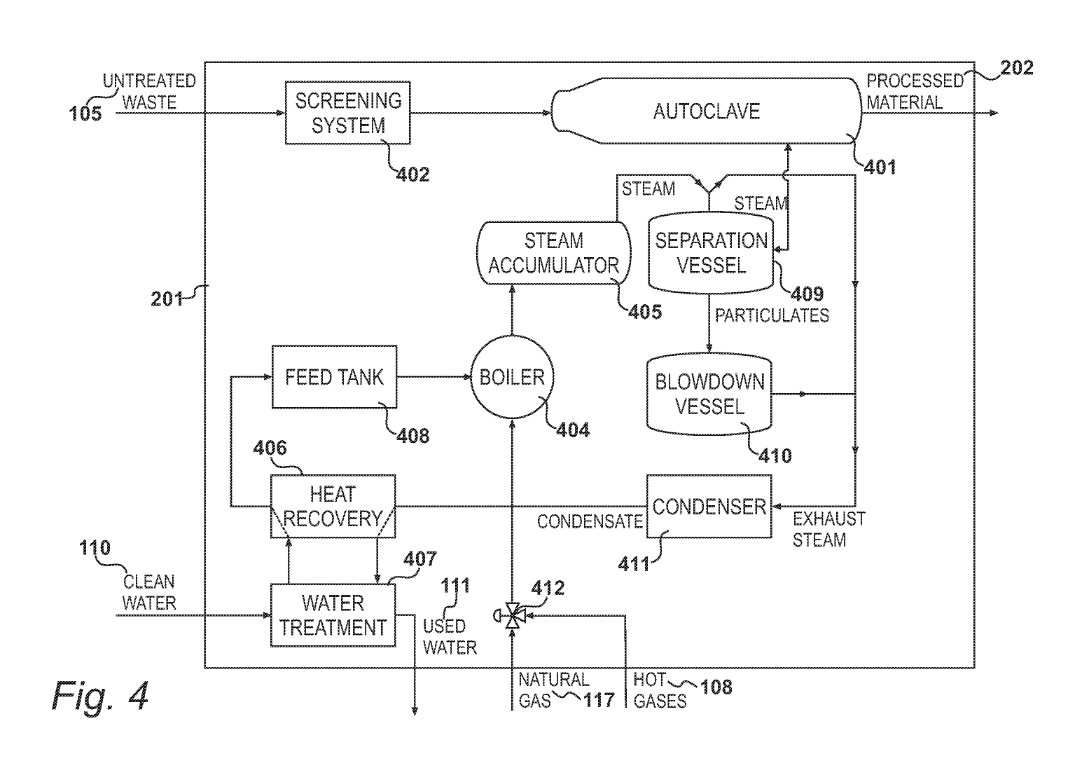

Untreated waste 105 is processed in steam treatment unit 101 (which is detailed in FIG. 4), using heat from hot gases 108, and water 110, to produce processed material 202, which is clean and sterile. This is passed to sorting unit 203 where it is sorted into fibre 106, plastics 107, and other materials 122.

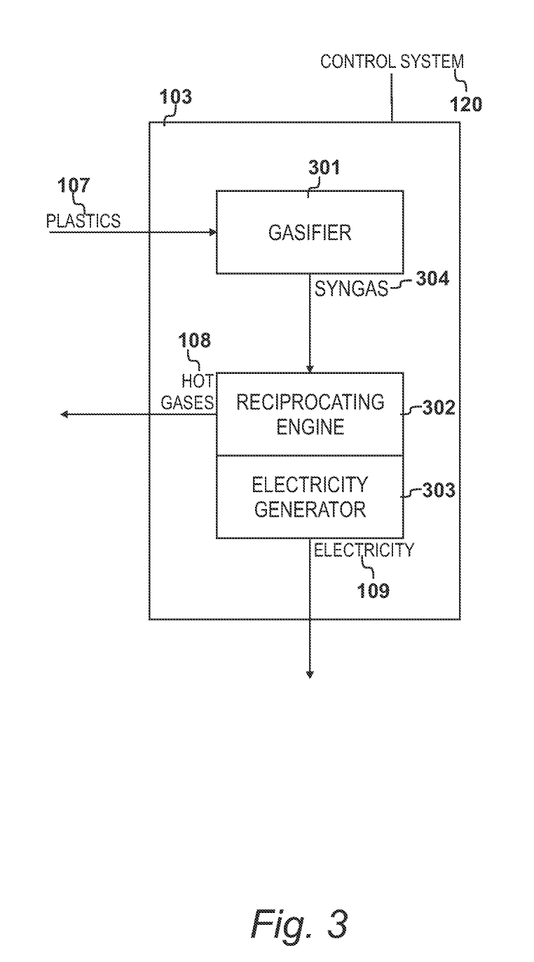

Sorting unit 203 comprises a mechanical separation system. Automatic systems take out the various fractions, and the relatively small amount of residual items are separated and removed manually. Fibre 106 is automatically separated from the other items and may be transported to storage (not shown) before being passed to fibre processing unit 104. Other materials 122, such as metals, bricks, and so on, are sent to a suitable place for recycling or reuse. However, plastics 107 are passed to energy generation unit 103 to generate hot gases 108 and electricity 109, as will be described with reference to FIG. 3.

### FIG. 3

FIG. 3 shows energy generation unit 103. It comprises a gasifier 301, and a reciprocating engine 302 connected to a electricity generator 303. Control system 120 provides monitoring and control of energy generation unit 103 (the details of this are not shown).

Plastics 107 are provided to gasifier 301, which gasifies the plastics using low oxygen combustion to produce synthesis gas, or syngas 304. This fuel is used by reciprocating engine 302 to turn electricity generator 303 and generate electricity 109. The exhaust gases from reciprocating engine 302 are passed as heat 108 to recycling unit 102.

Thus, recycling unit 102 is self-sufficient for heat, as the heat required to process the waste in steam treatment unit 201 is generated using plastics 107. Electricity 109 is used to provide electricity to the entire apparatus 101.

In the event of a breakdown of gasifier 301 or reciprocating engine 302, or in the case of an unexpected reduction in the amount of plastics 107 received from recycling unit 102, natural gas can be supplied to recycling unit 102 as will be discussed with respect to FIG. 4. In such a case, electricity supply 121 would be switched to receive electricity from the grid 118. As previously discussed, a supply of natural gas is provided in order to ensure that apparatus 101 does not need to shut down in the event of the breakdown of a component or an unexpected change in the composition of the untreated waste 105. However, in normal operation, natural gas 117 will not be required.

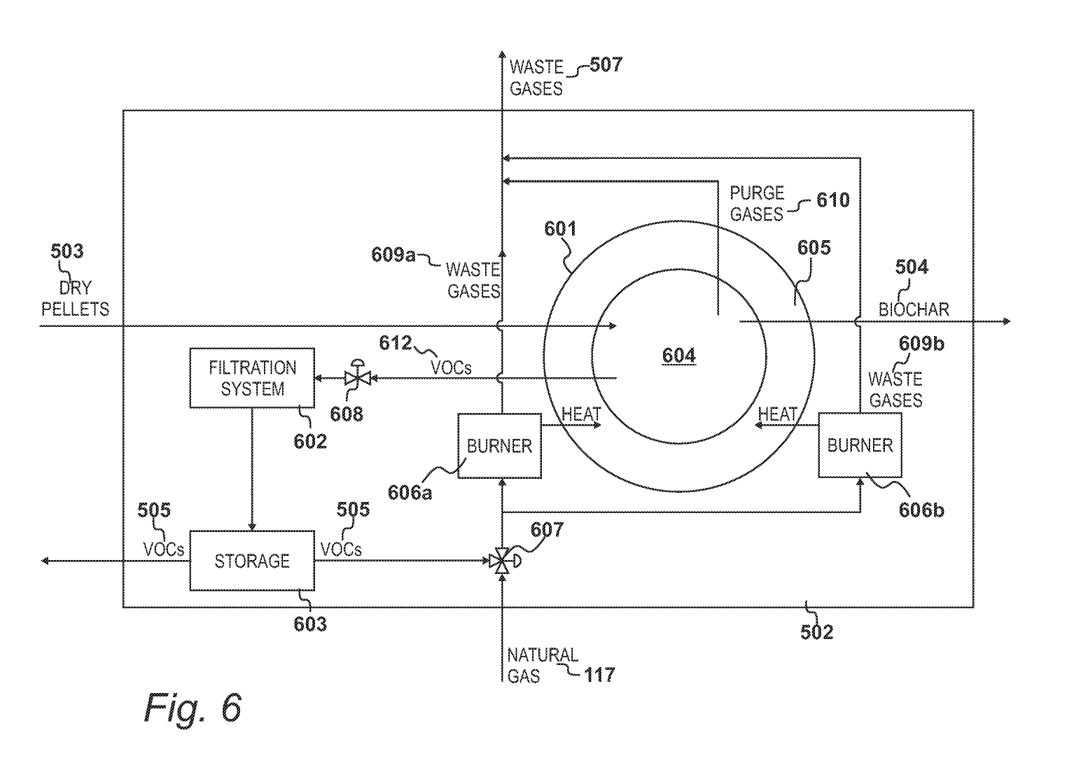

In place of the gasifier and reciprocating engine described herein, other systems for thermally converting plastics to generate heat may be used. In addition, the output of the unit may be altered to suit design requirements. In addition, as will be described with respect to FIG. 6, the heat produced by energy generation unit 103 could be used in fibre processing unit 104, with fibre processing unit 104 providing heat to recycling unit 102.

### FIG. 4

Steam treatment unit 201 is shown in FIG. 4. In this example, steam treatment unit 201 is adapted to treat municipal solid waste in which the treatment process results in the formation of particulates. Untreated waste 105 in the present example is municipal solid waste, which typically comprises glass, ceramics, waste food, cellulosics (paper, garden waste), metallics (aluminium cans, iron-based materials etc.) and so on. It is contemplated, however, that the unit described herein may be used with any form of solid waste.

Steam treatment unit 201 comprises an autoclave 401, to which untreated waste 105 is provided via a screening system 402, which removes bulky items. The screened waste is typically loaded into autoclave 401 for mechanical heat treatment by means of a conveyor system, with autoclave door operation being achieved automatically by control system 120. Autoclave 401 is charged with dry steam from a steam storage system, comprising a boiler 204 in combination with a steam accumulator 205. The conditions in the autoclave are brought to 160° C. and 5 bar gauge. These conditions are maintained and the autoclave is rotated for a total treatment time of around 30 to 60 minutes. The temperature and pressure are chosen to be high enough to comply with requirements for sterilisation of animal by-product, i.e. by killing bacteria, but not too high to begin melting plastic. In addition, the steam treatment results in labels, paint and grease being stripped from, for example, bottles and containers.

During autoclaving, all biogenic content of untreated waste 105 is converted into a fibre material which has a high proportion of cellulose content. As the fibre is the organic components of the MSW, it is accompanied by the input metals, plastic, glass, and so on. Thus, steam treatment of untreated waste 105 in autoclave 401 results in the generation of processed material 202, including fibre, plastics, and other materials, which is then provided to sorting unit 203.

In order to charge autoclave 401 with steam for the mechanical heat treatment process, the steam treatment unit 201 has a steam storage system comprising a boiler 404 and a steam accumulator 405. Boiler 404 is in this example a waste heat/gas boiler which recovers heat from hot gases 108, although in the event of hot gases 108 not being available, control valve 412 provides natural gas 117 to be thermally converted in boiler 404 instead. This allows the efficient production of dry, saturated steam. Water for the boiler 404 is pre-heated to a temperature below its boiling point, such as 80° C., in a heat recovery system 406 following treatment in a water treatment system 407, which comprises water purification apparatus of the known type. In an example, the heat recovery system 406 utilises a heat exchanger system for recovering heat from steam and condensate exhausted from the autoclave 401 during and after the mechanical heat treatment process. Contaminated water from the autoclave 401 is, following heat recovery, then passed to the water treatment system 407 for purification along with further processing by odour abatement apparatus of the known type therein.

Pre-heated water from the heat recovery system 406 is supplied to a feed tank 408 for storage and pre-treatment to remove impurities prior to being fed to the boiler 404.

Due to the high residual vapour pressure in the autoclave 401, steam is discharged at relatively high velocities, typically critical velocity. The velocity of steam exiting the autoclave 401 is dictated by the pressure differential. At the beginning of the discharge stage there is a large pressure differential, greater than critical pressure drop, and so the velocity is high. Gradually as steam is discharged, the pressure differential will drop and in order to maintain a sufficient flow velocity it may be necessary to apply a vacuum to maintain the rate of discharge. Appropriate vacuum apparatus (not shown) may therefore be provided downstream of the separation vessel 409 to facilitate this.

The steam when being exhausted from the autoclave 401 will tend to carry entrained with it some particulates such as splinters of glass, ceramic fragments and fibre. Separation vessel 409 separates these particulates from the flow of steam exiting the autoclave 401. In addition, autoclave 201 forming part of the solid waste treatment system of the present invention specifically does not have a particulate filter at its own outlet. A blowdown vessel 410 is provided below the separation vessel 409 for receipt of the particulates from the separation vessel 410. In this way, there is no filtration means in the autoclave which may become blocked.

Steam exiting the autoclave 401 following mechanical heat treatment is received at an inlet of the separation vessel 401, and passes, via an outlet, onward to the heat recovery system 406 via a condenser 411.

Input steam from steam accumulator 405 during the charging of autoclave 401 prior to mechanical heat treatment is routed via the outlet of separation vessel 409 and onward, via its inlet, to autoclave 401. Appropriate valve control by control system 120 facilitates this routing of the steam during the various operational phases of the system.

The above-described steam treatment unit is an example of the type of unit that can be used to treat waste with steam to produce clean cellulose fibre. Other suitable systems may be used. However, all such systems will require heat in order to generate steam, as provided by hot gases 108. In other embodiments, as described elsewhere, the heat may be provided from a different source.

### FIG. 5

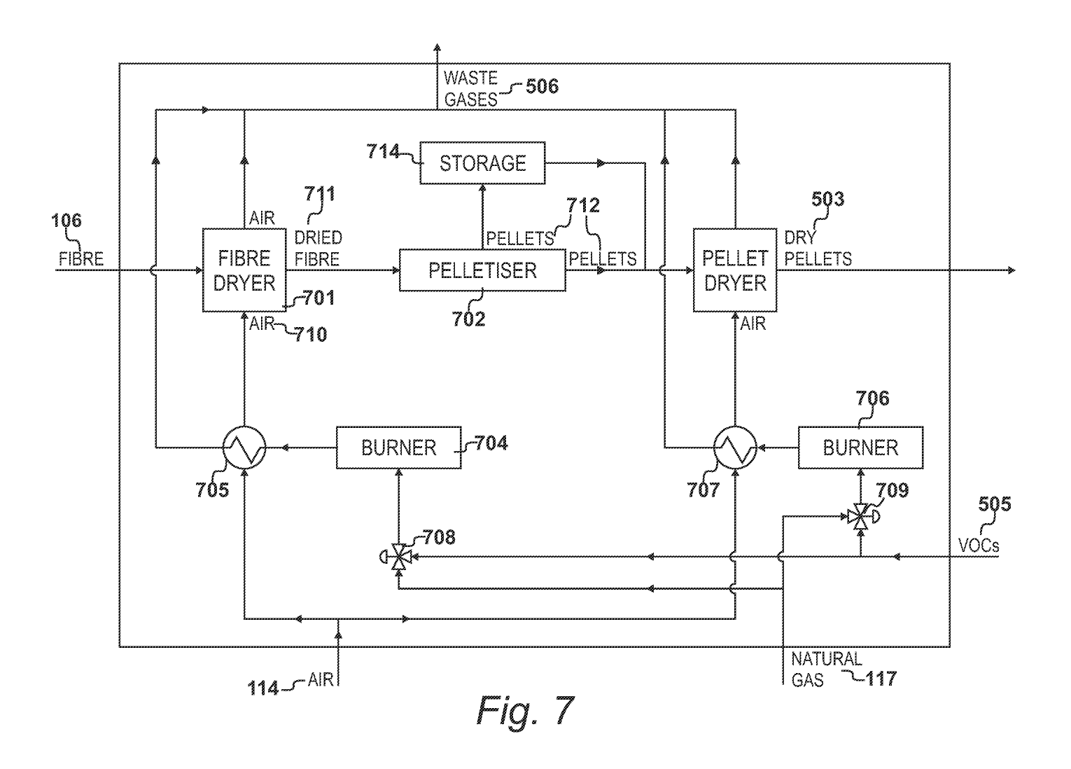

FIG. 5 shows fibre processing unit 104. It includes a drying unit 501 (detailed further in FIG. 7) and a torrefying unit 502 (detailed further in FIG. 6). Control system 120 provides monitoring and control of the units (the details of this are not shown).

Clean fibre 106 produced by recycling unit 102 is passed through drying system 501 to produce dry pellets 503 of fibre, which are torrefied in torrefying unit 502 to provide biochar 504.

The torrefying process produces volatile organic compounds (VOCs), and these are thermally converted to provide heat. Some are retained to provide heat in torrefying unit 502, as will be described further with respect to FIG. 6, and some are provided to drying unit 501. The system is self-sufficient under normal operation, but should an alternative source of fuel be required in the event of a breakdown, this is provided by natural gas 117.

Clean air 114 is used by drying unit 501 to dry fibre 106. Waste gases 506 from drying unit 501, including the air after it is used, and waste gases 507 from torrefying unit 502 are passed to electrostatic precipitator 508 to remove any solids, before being oxidized in thermal oxidiser 509. The vented gases 115 are therefore odourless.

Similarly to recycling unit 102, fibre processing unit 104 is self-sufficient. VOCs 505 produced by torrefying unit 502 are used to heat both drying unit 501 and torrefying unit 502. In another embodiment, VOCs 505 could be thermally converted to provide heat to recycling unit 102, and heat 108 produced by energy generation unit 103 could be used in fibre processing unit 104, as will be described with respect to FIG. 6. The exact configuration of the system is dependent on its size, design considerations, and the composition of the waste 105.

Typical domestic waste contains a large quantity of plastics, and therefore if this is the waste being processed then energy generation unit 103 will produce a considerable amount of electricity and heat. However, if recyclable materials are removed before the waste is supplied to apparatus 101, such that untreated waste 105 contains mainly organic material, then the heat and electricity generated by energy generation unit 103 will be small. However, the amount of fibre 106, and therefore the amount of VOCs produced by torrefying unit 502, will be greater. Therefore, depending on whether the recycling unit 102 or the fibre processing unit 104 needs more heat, and depending on the typical waste processed, a design decision will be made as to how to route heat through the system.

In a further embodiment, the apparatus could be designed such that both the heat generated by reciprocating engine 302 and the heat generated by thermally converting VOCs 505 could be supplied to both the recycling unit 102 and the fibre processing unit 104, with a control system 120 ensuring that both units are supplied at a consistent level. This might be an appropriate design if the composition of untreated waste 101 were likely to vary significantly.

### FIG. 6

Torrefying unit 502 is shown in FIG. 6. It comprises a torrefaction reactor 601, a VOC filtration system 602, and VOC storage 603.

Torrefaction reactor 601 comprises a chamber 604 and an annular heating jacket 605. Chamber 604 is cylindrical, and fibre in the form of dry pellets 503 is introduced at one end of chamber 604 and passed continuously through it, for example along a conveyer belt, before exiting as biochar 504. Heating jacket 605 is annular and surrounds the entire chamber 604. It is heated using a number of burners. In this example two burners 606a and 606b, positioned on opposite sides of the reactor 601, provide heat to jacket 605, but any suitable number and position of burners could be used. Jacket 605 is insulated to reduce heat loss.

Chamber 604 is purged by nitrogen during operation to be oxygen-free, and is heated by jacket 605 to around 270° C. This controlled atmosphere induces volatilisation of the VOCs within the fibre, which are extracted from the chamber as extracted VOCs 612, and passed through filtration system 602 to remove any entrained solids carried over from the chamber, before being stored in storage 603 as filtered VOCs 505.

Filtered VOCs 505 are then used to provide heat, both to the torrefaction reactor using burners 606a and 606b, and to the drying unit 501 (as will be described with reference to FIG. 7). In burners 606a and 606b, VOCs 505 are thermally converted in order to generate heat. In an unusual situation, for example filtration system 602 breaking down, natural gas 117 can replace the VOCs in the burners, and control valve 607 ensures that there is a constant flow of fuel to the burners. However, in normal operation, VOCs 505 will be sufficient to heat torrefaction reactor 601.

The temperature inside chamber 604 is held at around 270° C. by control system 120. Control system 120 is connected to sensors within torrefaction reactor 601, to burners 606a and 606b, and to control valve 608. When the temperature in chamber 604 deviates from a set point, control system 120 will cause the burners 606a and 606b to modulate to maintain a consistent temperature. Control valve 608 will modulate to maintain a consistent pressure within chamber 604; for instance when the pressure increases above a set point, control valve 608 will release more VOCs 612. In this way control system 120 maintains consistent conditions of temperature and pressure in chamber 604. Control system 120 is preferably configured so that burners 606a and 606b, and control valve 608, along with other elements controlled by control system 120, react proportionally and smoothly in order to achieve constant temperature and pressure within chamber 604.

Torrefaction reactor 601, under normal operating circumstances, produces more VOCs than are necessary to heat furnace 605. Thus VOCs 505 are also supplied to drying unit 501, as will be described with reference to FIG. 7.

The products of combustion discharged from burners 606a and 606b are output as waste gases 609a and 609b, which together with the nitrogen gas 610 used to purge oxygen from chamber 604, are output as waste gases 507 and sent to ESP 508. In the apparatus described herein, it is expected that there will be an excess of heat produced, and therefore there is no need to reclaim the heat from waste gases 609a and 609b. However, in other embodiments the heat could be reclaimed for use in any unit of the apparatus.

For example, in one embodiment, the heat from the waste gases 609a and 609b could be used to supplement heat drying unit 501, in case VOCs 505 are insufficient. In a further embodiment, waste gases 609a and 609b could be routed to steam treatment unit 201 for use in waste heat boiler 404 along with hot gases 108 from reciprocating engine 302. In a yet further embodiment, the waste gases could be used to generate additional electricity. As previously discussed, the size of the apparatus and the type of waste processed will inform such design considerations.

Burners are described herein, but other thermal conversion means suitable for thermally converting the VOCs could be used.

To create maximum redundancy in the system, all the above options could be included, with control system 120 routing the waste gases to the unit where they are of most use. This could reduce the necessity to rely on natural gas 117 in the event of a breakdown, but would increase the size, complexity and cost of the apparatus.

As described with reference to FIG. 5, in another embodiment the heat produced by energy generation unit 103 could be used to heat the torrefaction reactor. In that case, the reactor would comprise a heat exchanger instead of burners and there would be no waste gases produced. The VOCs would in that embodiment be thermally converted to provide heat for steam treatment unit 201, and the waste gases would be managed in any of the ways described above.

In an embodiment where both the steam treatment unit and the torrefaction reactor are powered by thermal conversion of either the VOCs or the plastics, it is envisaged either that both units could include a furnace or that there would be a central furnace. The control system 120 would route the VOCs in the first case or the heat produced in the second case, along with the heat from energy generation unit 103, according to the requirements of the steam treatment unit and the torrefaction reactor. Such an embodiment would add significantly to the size, complexity and cost of the apparatus, but would provide flexibility if the waste to be treated were extremely variable in composition.

### FIG. 7

Drying unit 501 is shown in FIG. 7. It includes a fibre dryer 701, a pelletiser 702, and a pellet dryer 703. Burner 704 provides heat to a heat exchanger 705 that heats air 114 for use in fibre dryer 701. Similarly, burner 706 produces heat for heat exchanger 707 that heats air 114 for use in pellet dryer 703. Both burner 704 and burner 706 are primarily supplied by VOCs 505. Under normal operating circumstances, enough VOCs are produced by the torrefaction process to provide heat for the whole fibre processing unit 104. However, in case of any breakdown, natural gas 117 may be used to supplement or replace VOCs 505. A control valve 708 controls the supply of either VOCs 505 or natural gas 117 into burner 704, and a control valve 709 does similarly for burner 706.

Air 114 is heated in each of the heat exchanges 705 and 707 and used in the dryers as follows. Fibre 106 is output from the autoclave with a moisture content of 30% to 40%. Fibre dryer 701 has a serpentine shape, and air 710, heated to around 150° C. by heat exchanger 705, is blown from bottom to top through the dryer. Fibre 106 is propelled at high velocity from the bottom to the top of the serpentine shape. This breaks open any fibres that are stuck together, and any heavier material that remains, such as shards of glass, fall to the bottom and are separated as residue. After reaching the top of the serpentine shape, the fibre exits the dryer as dried fibre 711, which has a moisture content of around 15 to 17%.

Dried fibre 711 is then milled to make it finer and pelletised in pelletiser 702, to form pellets 712. The pelletiser operates at 70° C. and is heated using electricity. A small amount of moisture is lost during the pelletising process. Pellets are preferred for use in torrefaction reactor 601 because they are easy to store and transport between units, and do not produce large amounts of dry powder that could be detrimental to machinery and human health.

In order for the torrefaction process to be as efficient as possible, the pellets are further dried in pellet dryer 703 to reduce the moisture content to 5% to 7%. Pellet dryer 703 is a belt dryer, and air 713, heated to around 250° C. by heat exchanger 707, is blown at low velocity through the belt. The pellets have a low surface area, and should remain static within the dryer to avoid damage. Therefore the pellets need a long dwell time within pellet dryer 703 before they are output as dry pellets 503. Dry pellets 503 are immediately transferred to the torrefaction reactor 601, since because of their low moisture content, dwell in normal atmospheric conditions will lead to reabsorption of moisture. Thus, pellets 702 may be stored in storage 714 before being transferred to the pellet dryer 703 as needed.

In this example, both dryers 701 and 703 operate at around 250° C. However, they may operate at any suitable temperature, and need not be at the same temperature. Control system 120 may vary the temperature of the dryers in order to produce a continuous system. For example, the pellet dryer 703 will preferably dry the pellets at the same rate that they are torrefied by the torrefying unit 502, in order to reduce dwell time before they enter torrefaction reactor 601. A second consideration is whether it is preferable to store wet fibre 106 (in which case fibre dryer 701 would preferably operate at the same rate as pellet dryer 703), or as pellets 712 (in which case fibre dryer 71 would preferably operate at the same rate as autoclave 401).

In order to reduce complexity, if the dryers are to operate at the same temperature then a single burner and heat exchanger could be included, rather than one for each dryer.

In the embodiment described with respect to FIG. 7, the heat for dryers 701 and 703 is provided entirely by thermally converting VOCs 505 (with natural gas 117 available in the case of a breakdown). However, as described previously, waste gases 609a and 609b from torrefaction reactor 601 could supplement the heat provided to the heat exchangers. In a further embodiment, the dryers could be heated using waste gases 108 from reciprocating engine 302, with the VOCs 505 being used to heat the steam treatment unit 201 instead. In a still further embodiment, if one dryer is determined to need considerably hotter air than the other, then the waste air and gases from the hotter dryer might be used to heat the air for the other one.

Several embodiments have therefore been described for the routing of heat around apparatus 101. In all cases, heat required for the autoclave 401, the drying unit 501, and the torrefying unit 502 are all generated by thermally converting either the plastics or the VOCs extracted from waste 105. In addition, electricity is generated from the waste, making apparatus 101 self-sufficient. Natural gas and grid electricity are provided only for use in the event of a breakdown, in order to keep the apparatus running. The self-sufficiency of the unit, which takes unwanted waste and creates a useable product from it, means that this apparatus is sustainable, and reduces emissions of greenhouse gases over other methods of disposing of waste.

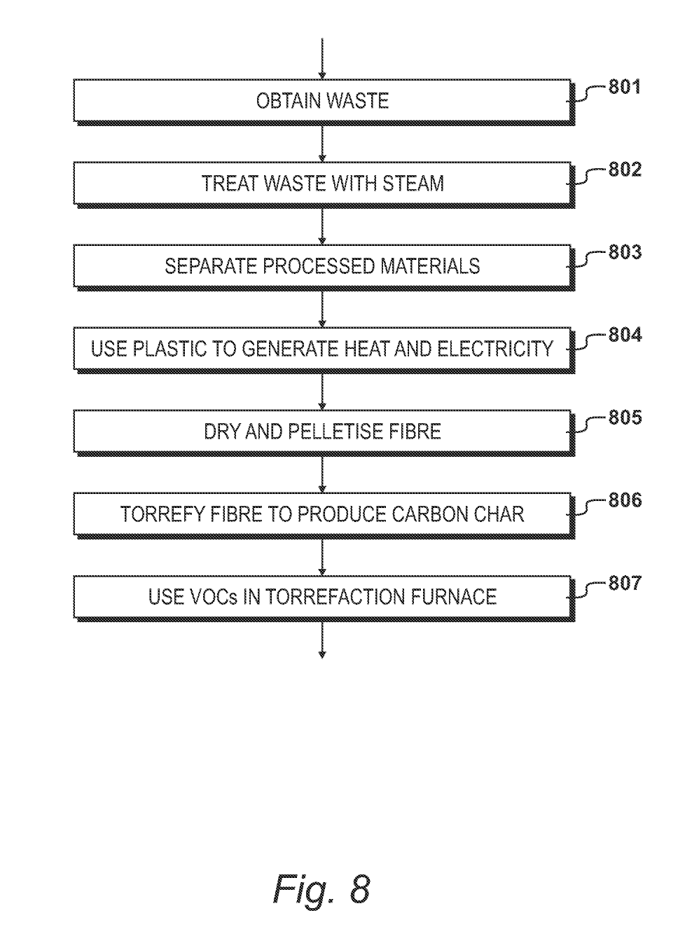

### FIG. 8

FIG. 8 shows steps taken when operating apparatus 101 to process waste into carbon char. Consecutive steps are shown, following the journey of a single load of waste. However, the apparatus runs continuously and therefore all the steps are being carried out simultaneously at all times.

At step 801 waste 105 is obtained, usually from a local authority or company that has collected it from households or commercial premises. At step 802 the waste is treated with high pressure steam in an autoclave 401 to produce processed material 202, which is separated into its parts at step 803, including fibre 106 and plastics 107.

At step 804 the plastics 107 are thermally converted to generate heat and electricity for use in apparatus 101. At step 805 the fibre 106 is dried and pelletised to produce dry pellets 503, and at step 806 the pellets are torrefied to produce carbon char 504. At step 807, VOCs 612 produced by the torrefaction process are thermally converted to heat torrefaction reactor 601.

1. Apparatus for processing waste-derived cellulose fibre into carbon char, comprising:
an autoclave for treating waste with steam to produce processed material, said processed material including cellulose fibre and plastics;
a drying system for drying said cellulose fibre;
a torrefying unit for torrefying said dried cellulose fibre to produce carbon char and VOCs; and
thermal conversion means for thermally converting either said plastics or said VOCs, in order to provide heat for at least one of said autoclave, said drying system or said torrefying unit.

2. Apparatus according to claim 1, wherein said torrefying unit comprises a torrefaction reactor, and said thermal conversion means thermally converts said VOCs to provide heat to said torrefaction reactor.

3. Apparatus according to claim 2, wherein said thermal conversion means is a burner.

4. Apparatus according to claim 2, wherein torrefaction reactor comprises said burner and a chamber, and said burner thermally converts said VOCs to provide heat to said chamber.

5. Apparatus according to claim 1, wherein said drying system comprises a first dryer to dry said cellulose fibre to a first moisture level, and a second dryer to dry said cellulose fibre to a second moisture level that is lower than said first moisture level.

6. Apparatus according to claim 1, further including an energy generation unit that produces heat to generate steam for said autoclave.

7. Apparatus according to claim 6, wherein
said energy generation unit includes said thermal conversion means; and
said apparatus further comprises:
a separation system for separating said processed material into cellulose fibre, plastics, and other materials;
a first conduit from said separation system to said drying system for providing said cellulose fibre to said drying system; and
a second conduit from said separation system to said energy generation system for providing said plastics to said energy generation system.

8. Apparatus according to claim 7, wherein said energy generation unit comprises:
a gasifier for processing said plastics into synthesis gas; and
a reciprocating engine and connected electricity generator for generating electricity using said syngas.

9. Apparatus according to claim 8, wherein waste gases produced by said reciprocating engine are output as heat to generate steam for said autoclave.

10. Apparatus according to claim 8, wherein waste gases produced by said reciprocating engine are output as heat to said torrefying unit.

11. Apparatus according to claim 6, wherein said thermal conversion means thermally converts said VOCs to provide heat to generate steam for said autoclave.

12. A method of producing carbon char from waste, comprising the step of processing waste by:
treating said waste with high pressure steam to produce processed material that includes cellulose fibre and plastics, and
torrefying said cellulose fibre to produce carbon char and VOCs;
wherein heat used during said step of processing waste is produced by thermally converting at least one of said plastics and said VOCs.

13. A method according to claim 12, wherein said plastics are thermally converted to provide heat for the step of torrefying said cellulose fibre.

14. A method according to claim 12, wherein said plastics are thermally converted to provide heat for the step of treating said waste with steam.

15. A method according to claim 12, wherein said VOCs are thermally converted to provide heat for the step of torrefying said cellulose fibre.

16. A method according to claim 12, wherein said VOCs are thermally converted to provide heat for the step of treating said waste with steam.

17. A method according to claim 12, wherein said plastics are thermally converted by the steps of:
gasifying said plastics to produce synthesis gas;
using said gas to power an engine; and
extracting heat from the waste gases of said engine.

18. A method according to claim 17, further including the step of using the movement of said engine to generate electricity.

19. A method according to claim 12, wherein said VOCs are thermally converted using a burner.

20. A method according to claim 12, wherein the waste gases produced by thermally converting said VOCs are used to provide heat for one or more of the steps of:
treating said waste with steam;
drying said cellulose fibre; and
torrefying said cellulose fibre.
